(19) United States
(12) Patent Application Publication
(10) Pub. No.: US 2012/0006731 A1
(43) Pub. Date: Jan. 12, 2012

(54) FILTER WITH REUSABLE BYPASS VALVE AND INNER ASSEMBLY

(76) Inventor: Edwin C. Swift, JR., Pepper Pike, OH (US)

(21) Appl. No.: 12/830,901

(22) Filed: Jul. 6, 2010

(51) Int. Cl. B01D 35/147; B01D 35/30

(52) U.S. Cl. 210/133; 210/442; 210/315; 210/418

(57) ABSTRACT

A filter unit includes an outer filter assembly, a bypass valve assembly, and an inner filter assembly. The bypass valve assembly can be separated from the outer filter assembly, allowing the bypass valve assembly to be recycled/reused when the outer filter assembly is disposed of. In addition, the bypass valve assembly and the inner filter assembly can be connected together, then inserted into the outer filter assembly.

### BACKGROUND

The present disclosure relates to filter assemblies used in various equipment, such as hydraulic equipment. In particular, the filter assemblies described herein can be separated into different components, so that some components can be reused and only certain components are replaced and disposed. This reduces expenses, minimizes disposal volumes, and enhances equipment operating efficiencies.

Many devices include hydraulic circuits or lubrication circuits, including those found in wind turbine, power generation, machine tool, and other industrial applications. In such circuits, a fluid, such as an oil or lubricant or gas or aqueous fluid, flows through a circuit and can pick up debris, i.e. various foreign particles of varying size and composition. Such foreign particles are considered contaminants, and fluid filtration systems are typically used to remove the debris from the fluid. A filter assembly or cartridge is placed within a housing. The filter assembly includes a porous article or material for separating suspended particulate matter or contaminants from the liquid by passing the liquid through pores in the filter and sieving out the solids. The fluid to be purified is introduced into the housing through an inlet, passes through the filter assembly, and exits through an outlet. The filter assembly is typically used only once over a period of time before removal and replacement.

Eventually, as the filter assembly successfully traps the debris, the pores in the filter assembly become clogged and the filter assembly must be replaced. However, it is not always easy to determine when the filter assembly must be changed. If the filter assembly is inadequately serviced, it is possible for incoming fluid to be unable to flow through the filter assembly to the outlet. This can result in little or no fluid being available to flow through the circuit, causing problems in the system. To prevent this event, the filter assembly may include a pressure relief or bypass valve. After the pressure exceeds a predetermined value, the pressure relief valve opens, allowing the fluid to bypass the clogged filter assembly.

The pressure relief valve is usually an integral part of the filter assembly. As such, when the filter assembly is clogged and must be disposed of, the pressure relief valve is also disposed with the entire filter assembly. This results in additional unnecessary disposal volume. In addition, because filter elements containing metal components are generally regarded as a hazardous material, they must be disposed of according to stringent regulations, which increase disposal costs. In addition, the pressure relief valve increases the cost of making and shipping the original filter assembly,

### BRIEF DESCRIPTION

The present disclosure relates to several devices and apparatuses that can be used to filter debris out of various fluids. Generally speaking, a bypass valve assembly and a filter assembly are disclosed, in which the bypass valve can be separated from the filter assembly and reused or recycled, while only the filter assembly is replaced or disposed of. In addition, a filter unit is disclosed which comprises an outer filter assembly, an inner filter assembly, and a bypass valve assembly. The inner filter assembly is joined or connected to the bypass valve assembly, and is located inside the outer filter assembly. This construction allows the inner filter assembly to be replaced separately from the outer filter assembly.

Disclosed in embodiments is a bypass valve assembly that comprises a hub, a pressure relief element, and a first rotary complementary joining mechanism. The hub comprises a central bore, an upper portion, a lower portion, and an outlet aperture in the lower portion. An outer diameter of the lower portion is less than an outer diameter of the upper portion. The pressure relief element acts to prevent flow through the outlet aperture until a pressure differential value is exceeded. The pressure relief element is positioned between the hub and the first rotary complementary joining mechanism.

The pressure relief element can be located adjacent to the hub by an upper support member, a pin, and a nut. The upper support member comprises a core and a plurality of legs extending radially away from the core. The core has a central aperture. The upper support member is located in the hub central passageway, with the legs engaging an inner lip in the central passageway. The pin comprises a shank, a head on a first end of the shank, and a thread on a second end of the shank. The shank passes through the upper support member central aperture and the pressure relief element so that the second end of the shank extends beyond the pressure relief element. The nut is secured to the second end of the shank. A portion of the second end of the shank extending beyond the nut acts as the first rotary complementary joining mechanism.

The pressure relief element can comprise a sealing member, a spring, and a spring support member. The sealing member has a central aperture and has a diameter sized to close the hub central passageway. The spring has an upper end and a lower end. The spring support member engages the lower end of the spring, and has a central aperture. Generally, the pin will pass through the central apertures of the sealing member and the spring support member. The spring is located between the sealing member and the spring support member, and can also be described as surrounding the shank.

Also disclosed in embodiments is a bypass valve assembly that comprises a hub, an upper support member, a sealing member, a spring, a spring support member, a pin, and a nut. The hub comprises a central passageway, an inner lip in the central passageway, an upper portion, and a lower portion, wherein an outer diameter of the lower portion is less than an outer diameter of the upper portion. The upper support member comprises a core and a plurality of legs extending radially away from the core, the core having a central aperture, and the upper support member being located in the hub central passageway so that the legs engage the inner lip. The sealing member has a central aperture and has a diameter sized to close the hub central passageway. The spring has an upper end and a lower end. The spring support member engages the lower end of the spring, and has a central aperture. The pin comprises a shank, a head on a first end of the shank, and a thread on a second end of the shank. A nut is secured to the second end of the shank. The shank passes sequentially through the upper support member central aperture, the sealing member central aperture, and the spring support member central aperture. The shank is surrounded by the spring, the spring being located between the sealing member and the spring support member.

In embodiments, the lower portion of the hub has an inner diameter, and the upper end of the spring has a diameter which is between the inner diameter of the lower portion and the outer diameter of the lower portion.

The upper end of the spring may have a diameter which is substantially equal to the diameter of the sealing member.

A diameter of the lower end of the spring should be less than or equal to a diameter of the spring support member.

In some embodiments, the spring support member is a lower spring cup comprising a support surface and a sidewall along a circumference of the support surface. The support surface and the sidewall form a recess into which the lower end of the spring is seated. The bypass valve assembly may further comprise a lower washer located on a side of the lower spring cup opposite the lower end of the spring. In other embodiments, the spring support member is in the form of a washer.

The bypass valve assembly may further comprise an annular recess in an exterior surface of the lower portion of the hub. An o-ring is placed in the annular recess.

The bypass valve assembly may further comprise an upper washer adjacent the sealing member and located between the sealing member and the upper end of the spring. A diameter of the upper washer can be substantially equal to the diameter of the sealing member.

The bypass valve assembly may further comprise an upper spring cup, the upper spring cup being located between the sealing member and the spring. The upper spring cup has a recess into which the upper end of the spring is seated. In some embodiments, the lower portion of the hub has an inner diameter, and a diameter of the upper spring cup is greater than the inner diameter of the lower portion of the hub.

The bypass valve assembly may further comprise an upper washer and an upper spring cup, the upper washer being located between the sealing member and the upper spring cup, and the upper spring cup forming a recess into which the upper end of the spring is inserted.

The sealing member may be made from a fluorocarbon. The pin shank can include a non-threaded portion between the head and the thread.

Disclosed in other embodiments is a bypass valve assembly, consisting essentially of: a hub comprising a sidewall surrounding a central bore, an inner lip in the central bore, an upper portion, a lower portion, and an outlet aperture in the lower portion; an upper support member comprising a core and a plurality of legs extending radially away from the core, the core having a central aperture, and the legs engaging the inner lip of the hub; a sealing member having a central aperture and having a diameter sized to close the outlet aperture of the hub; an upper washer having a diameter substantially equal to the diameter of the sealing member and having a central aperture; a spring having an upper end and a lower end; an upper spring cup located between the upper washer and the upper end of the spring, the upper spring cup having a recess into which the upper end of the spring is seated and having a central aperture; a lower spring cup having a recess into which the lower end of the spring is seated and having a central aperture; a lower washer on a side of the lower spring cup opposite the recess, and having a central aperture; a pin comprising a shank, a head on a first end of the shank, and a thread on a second end of the shank; and a nut threaded to the second end of the shank; wherein the shank passes sequentially through the upper support member central aperture, the sealing member central aperture, the upper washer central aperture, the upper spring cup central aperture, the spring, the lower spring cup central aperture, and the lower washer central aperture.

The sidewall of the hub can be knurled on the upper portion of the hub.

In embodiments, the sealing member diameter, the upper washer diameter, a spring upper end diameter, a spring lower end diameter, an upper spring cup diameter, a lower spring cup diameter, and a lower washer diameter are each less than an outer diameter of the lower portion of the hub.

In other embodiments, an exterior surface of the lower portion of the hub includes an annular recess, and an o-ring is located in the annular recess.

Additionally disclosed herein is a filter assembly, comprising: a perforated tube having a first open end and a second open end; an annular filter element having a first end and a second end, and surrounding the perforated tube; a first end cap attached to the first end of the annular filter element, and comprising an annular surface and a central sidewall; a flange comprising an annular surface and a central sidewall, the flange being attached to the second end of the annular filter element; and an end cover comprising an annular surface, a central sidewall extending from the annular surface, and a lip extending inwards from the central sidewall, the end cover being attached to the flange; wherein the first end cap defines a first opening; wherein the flange and the end cover cooperate to define a second opening; wherein the first opening has a diameter less than a diameter of the second opening.

The first end cap can be attached to the annular filter element using an epoxy resin. The first end cap may further comprise two catches and a handle engaging the two catches. In some embodiments, the second opening can further include an o-ring between the lip and the flange, and the first opening does not have an o-ring.

Also disclosed is a recyclable filter element comprising a filter assembly and a bypass valve assembly. The filter assembly comprises: a perforated tube; an annular filter medium surrounding the perforated tube; a first end cap securing one end of the perforated tube and the annular filter medium, and defining a first opening; and a second end cap securing an opposite end of the perforated tube and the annular filter medium, and defining a second opening; wherein the first opening has a diameter less than a diameter of the second opening. The bypass valve assembly comprises: a hub comprising a central bore, an upper portion, a lower portion, and an outlet aperture in the lower portion, wherein an outer diameter of the lower portion is less than an outer diameter of the upper portion; a pressure relief element that acts to prevent flow through the outlet aperture until a pressure differential value is exceeded; and a first rotary complementary joining mechanism. The pressure relief element is between the hub and the first rotary complementary joining mechanism. The lower portion of the bypass valve assembly hub fits into and makes a sealing engagement with the first opening of the filter assembly. The upper portion of the bypass valve assembly hub sits on the first end cap. The lower portion of the bypass valve assembly hub is unable to make a sealing engagement with the second opening of the filter assembly. The bypass valve assembly can be separated from the filter assembly.

Also disclosed is a recyclable filter element comprising a filter assembly and a bypass valve assembly. The filter assembly comprises: a perforated tube; an annular filter medium surrounding the perforated tube; a first end cap securing one end of the perforated tube and the annular filter medium, and defining a first opening; and a second end cap securing an opposite end of the perforated tube and the annular filter medium, and defining a second opening; wherein the first opening has a diameter less than a diameter of the second opening. The bypass valve assembly comprises: a hub comprising a central passageway and an inner lip in the central passageway, an upper portion, and a lower portion, wherein an outer diameter of the lower portion is less than an outer diameter of the upper portion; an upper support member comprising a core and a plurality of legs extending radially away from the core, the core having a central aperture, the upper support member being located in the hub central passageway so that the legs engage the inner lip; a sealing member having a central aperture and having a diameter sized to close the hub central passageway at the lower portion of the hub; a spring having an upper end and a lower end; a spring support member engaging the lower end of the spring, and having a central aperture; a pin comprising a shank, a head on a first end of the shank, and a thread on a second end of the shank; and a nut secured to the second end of the shank; wherein the shank passes sequentially through the upper support member central aperture, the sealing member central aperture, and the spring support member central aperture; and wherein the shank is surrounded by the spring, the spring being located between the sealing member and the spring support member. The lower portion of the bypass valve assembly hub fits into and makes a sealing engagement with the first opening of the filter assembly; the upper portion of the bypass valve assembly hub sits on the first end cap; the lower portion of the bypass valve assembly hub is unable to make a sealing engagement with the second opening of the filter assembly; and the bypass valve assembly can be separated from the filter assembly.

The diameter of the opening diameter of the filter assembly can be greater than the outer diameter of the upper portion of the hub.

The recyclable filter element may further comprise an annular recess in an exterior surface of the lower portion of the hub, and an o-ring placed in the annular recess.

In embodiments, the first end cap of the filter assembly does not include an o-ring, and the second end cap includes an o-ring located in an annular recess.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is an exploded view of a first exemplary embodiment of a bypass valve assembly.

FIG. 2A is a perspective view of an exemplary embodiment of a hub used in a bypass valve assembly.

FIG. 2B is a side cross-sectional view of the hub of FIG. 2A.

FIG. 2C is an exterior side view of the hub of FIG. 2A.

FIG. 2D is a top view of the hub of FIG. 2A.

FIG. 3 is a side view of a spring used in a bypass valve assembly.

FIG. 4A is a perspective view of a first exemplary embodiment of a spring support member used in a bypass valve assembly.

FIG. 4B is an exterior side view of the spring support member of FIG. 4A.

FIG. 4C is a perspective view of a second exemplary embodiment of a spring support member, i.e. a spring cup, used in a bypass valve assembly.

FIG. 4D is a side cross-sectional view of the spring support member of FIG. 4C.

FIG. 5A is a perspective view of an exemplary embodiment of a sealing member used in a bypass valve assembly.

FIG. 5B is an exterior side view of the sealing member of FIG. 5A.

FIG. 6A is a perspective view of a first exemplary embodiment of an upper support member used in a bypass valve assembly.

FIG. 6B is an exterior side view of the upper support member of FIG. 6A.

FIG. 6C is a top view of the upper support member of FIG. 6A.

FIG. 6D is a perspective view of a second exemplary embodiment of an upper support member used in a bypass valve assembly.

FIG. 7 is a perspective view of an exemplary embodiment of a pin used in a bypass valve assembly.

FIG. 8A is an exploded view of a second exemplary embodiment of a bypass valve assembly.

FIG. 8B is a side cross-sectional view of the bypass valve assembly of FIG. 8A in an assembled state.

FIG. 9 is an exterior perspective view of a first exemplary embodiment of an outer filter assembly of the present disclosure.

FIG. 10 is an exploded cross-sectional view of the outer filter assembly of FIG. 9.

FIG. 11A is a perspective view of an exemplary end cap used with the outer filter assembly, allowing the use of a handle.

FIG. 11B is a top view of the end cap of FIG. 11A.

FIG. 11C is a side cross-sectional view of the end cap of FIG. 11A.

FIG. 12A is a perspective view of a first embodiment of a perforated tube used with the outer filter assembly, having circular perforations.

FIG. 12B is a side view of the perforated tube of FIG. 12A.

FIG. 13 is a top view of an annular pleated filter element.

FIG. 14A is a perspective view of a first exemplary embodiment of a flange used with the outer filter assembly.

FIG. 14B is a side cross-sectional view of the flange of FIG. 14A.

FIG. 15A is a perspective view of a second exemplary embodiment of a flange used with the filter assembly.

FIG. 15B is a side cross-sectional view of the flange of FIG. 15A.

FIG. 16A is a perspective view of an exemplary end cover used in conjunction with a flange on the outer filter assembly.

FIG. 16B is a side cross-sectional view of the end cover of FIG. 16A.

FIG. 16C is a top view of the end cover of FIG. 16A.

FIG. 17 is a side cross-sectional view showing a bypass valve assembly in sealing engagement with the upper end of an outer filter assembly. It should be noted that the perforated tube has rectangular perforations.

FIG. 18A is a perspective view of an exemplary embodiment of an inner filter assembly.

FIG. 18B is a side cross-sectional view of the inner filter assembly of FIG. 18A.

FIG. 19A is a perspective view of a closed end cap used with the inner filter assembly.

FIG. 19B is a side cross-sectional view of the closed end cap of FIG. 19A.

FIG. 20A is a perspective view of a second exemplary embodiment of another end cap used with the inner filter assembly, having a central bore or opening.

FIG. 20B is a side cross-sectional view of the end cap of FIG. 21A.

FIG. 21 is a side cross-sectional view showing a bypass valve assembly in threaded engagement with the upper end of an inner filter assembly.

FIG. 22 is a side cross-sectional view showing a filter unit, with the bypass valve assembly in threaded engagement with the upper end of the inner filter assembly, and with the bypass valve assembly in sealing engagement with the upper end of the outer filter assembly.

### DETAILED DESCRIPTION

A more complete understanding of the parts, assemblies, and processes disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of from about 2 to about 10″ also discloses the range “from 2 to 10.”

As used in the specification and in the claims, the term “comprising” may include the embodiments “consisting of” and “consisting essentially of.”

The present disclosure relates to different embodiments of filter units and assemblies that can be used in fluid filtration systems. Generally, the filter unit comprises a filter assembly and a bypass valve assembly. The bypass valve assembly can also be considered a pressure relief valve, allowing fluid flow to bypass the filter assembly when the pressure differential between two sides of the filter exceeds a predetermined value. The filter assembly includes a porous article or material for separating suspended particles from a fluid by passing the fluid through pores in a filter. The filter assembly and the bypass valve assembly are two separate devices which can be joined together, in contrast to prior filter units, in which the two devices are integrated and cannot be separated.

Generally speaking, the bypass valve assembly can be considered as comprising a hub, a pressure relief element, and a first rotary complementary joining mechanism. As described further herein, the first rotary complementary joining mechanism can be joined with a second rotary complementary joining mechanism on an inner filter assembly to connect the bypass valve assembly and the inner filter assembly together.

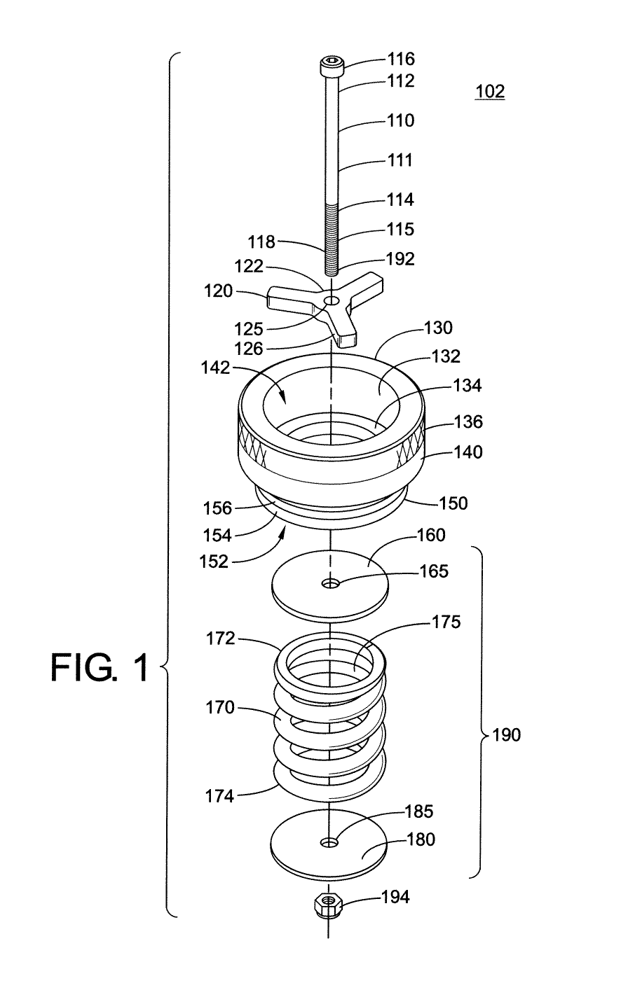

FIG. 1 is an exploded view of a first exemplary embodiment of a bypass valve assembly of the present disclosure. The bypass valve assembly 102 is shown here from top to bottom as comprising a pin 110, an upper support member 120, a hub 130, a sealing member 160, a spring 170, a spring support member 180, and a nut 194.

Beginning from the top, the pin 110 has a shank 111. A head 116 is located on a first end 112, upper end, or top end of the shank. A thread 115 is located on a second end 114, lower end, or bottom end of the shank. The second end can also be considered a pin end 118 having an external thread.

The upper support member 120 comprises a core 122 and a plurality of legs 126 extending radially away from the core, i.e. outwards from the core. A central aperture 125 is present in the core 122.

The hub 130 has a central passageway 132. An inner lip 134 is present in the central passageway. The hub can also be described being formed from a sidewall 136 that surrounds the central passageway. The thickness of the hub sidewall varies, forming an upper portion 140 and a lower portion 150 in the hub. The central passageway 132 extends through the hub, from an inlet aperture 142 in the upper portion 140 to an outlet aperture 152 in the lower portion 150. The legs 126 of the upper support member 120 will rest on or engage the inner lip 134 of the hub 130. An o-ring (not shown) is located in an annular recess 156 on the exterior surface 154 of the lower portion 150.

The sealing member 160 has a central aperture 165. The sealing member is sized to close the hub central passageway, i.e. the outlet aperture 152, at the lower portion of the hub.

The spring 170 has an upper end 172 and a lower end 174. The spring pushes the sealing member 160 against the outlet aperture 152.

The spring support member 180 engages the lower end of the spring. A central aperture 185 is also present in the spring support member. As shown here, the spring support member has the form of a washer.

The bypass valve assembly 102 is formed by passing the shank 111 of the pin sequentially through the upper support member central aperture 125, the sealing member central aperture 165, and the spring support member central aperture 185. The shank 111 is then secured with the nut 194 on the second end 114 of the shank. The spring 170 surrounds the shank 111, and is located between the sealing member 160 and the spring support member 180. Alternatively, the spring 170 can also be considered as having a central aperture 175. The shank 111 could then be described as passing sequentially through the upper support member central aperture 125, the sealing member central aperture 165, the spring central aperture 175, and the spring support member central aperture 185.

The upper support member central aperture 125, the sealing member central aperture 165, and the spring support member central aperture 185 are coaxial with each other. The hub 130, upper support member 120, sealing member 160, spring 170, and spring support member 180 can also be considered as being coaxial with each other.

As is understood by those of ordinary skill in the art, this construction of the bypass valve results in the spring 170 biasing the sealing member 160 against the outlet aperture 152. Once the fluid pressure (i.e. through the hub central passageway, or on the side of the sealing member opposite the spring) exceeds a predetermined value, the spring is pushed downwards and fluid can flow through the outlet aperture 152, reducing the fluid pressure. It is contemplated that the bypass valve assembly will be offered at three different pressure settings: 1 bar (15 psig), 3 bar (43 psig), and 6 bar (87 psig). The pressure rating can be changed by varying the diameter of the spring, the length of the spring, and the diameter of the spring wire. In particular, changing the length of the shank 111 that extends beyond the nut 194 will adjust the pressure rating at which the valve will open.

In this embodiment, the sealing member 160, spring 170, and spring support member 180 can be considered the pressure relief element 190, which is located adjacent the outlet aperture 152 of the hub. The pin 110, upper support member 120, and nut 194 are used to locate and maintain the pressure relief element 190 relative to the hub. The pin end 118 of the shank, which has an external thread, extends beyond the nut 194, and can be considered the first rotary complementary joining mechanism 192. As will be seen later, the remaining thread on the pin end of the shank can be inserted into another threaded recess, which acts as the second rotary complementary joining mechanism. The first rotary complementary joining mechanism is present on, and defines, one end of the bypass valve assembly.

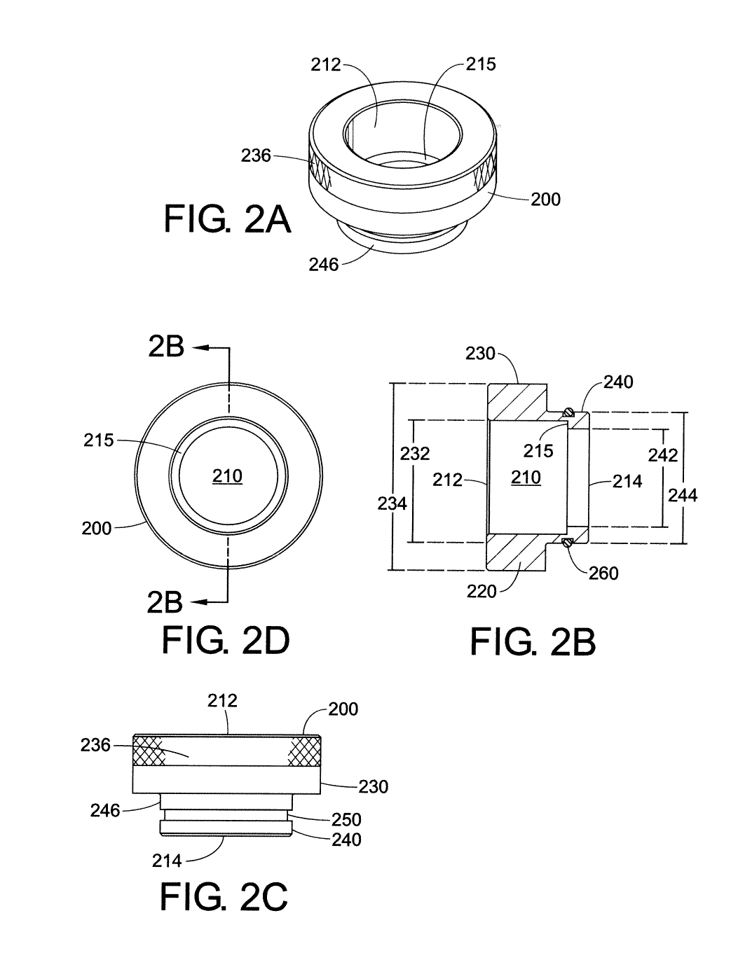

FIGS. 2A-2D show various views of an exemplary embodiment of a hub 200 that can be used in the bypass valve assembly. As seen in FIG. 2D, the central passageway 210 extends entirely through the hub from the inlet aperture 212 to the outlet aperture 214. Alternatively, the hub can be described as a sidewall 220 that surrounds a central bore 210. The upper portion 230 of the hub has an outer diameter 234 and an inner diameter 232. Similarly, the lower portion 240 of the hub has an outer diameter 244 and an inner diameter 242. The diameter of the outlet aperture is the same as the inner diameter 242 of the lower portion of the hub. The inner lip 215 is formed by the difference between the inner diameter 232 of the upper portion and the inner diameter 242 of the lower portion. It should be noted that the upper portion 240 and the lower portion 250 are defined from the exterior surface, not by the location of the inner lip 215, as seen in the cross-sectional view of FIG. 2B. As seen in FIG. 2C, the exterior surface 236 of the upper portion can be knurled to provide users with a good grip for handling the bypass valve assembly. In embodiments, an annular recess 250 is also provided in an exterior surface 246 of the lower portion. An o-ring 260 is located in the annular recess to provide a seal.

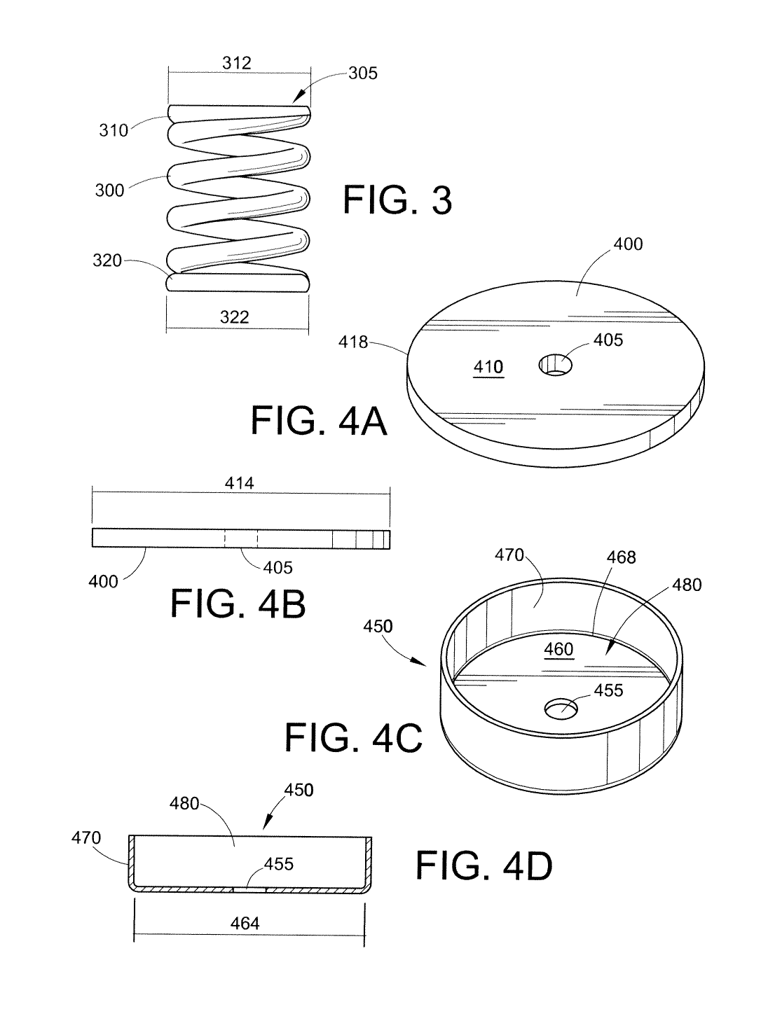

FIG. 3 is a side view of the spring 300. The upper end 310 of the spring has a diameter 312. The lower end 320 of the spring also has a diameter 322. The upper end diameter 312 and the lower end diameter 322 are shown here as equal, so that the spring has a cylindrical shape. However, it is also contemplated that the diameters may vary. The spring 300 can be considered as having a central aperture 305 that extends between the upper end 310 and the lower end 320.

FIG. 4A and FIG. 4B are views of one embodiment of a spring support member 400. Here, the spring support member is in the shape of a washer. The spring support member 400 has a support surface 410. The support surface is flat. The support surface 410 has a circumference or outer perimeter 418. The support surface 410 also has a diameter 414. A central aperture 405 is present in the support surface 410.

FIG. 4C and FIG. 4D are views of another embodiment of a spring support member. This spring support member is also referred to herein as a spring cup 450. The spring cup has a support surface 460. The support surface 460 has a circumference or outer perimeter 468. The support surface 460 also has a diameter 464. A central aperture 455 is present in the support surface 460. A sidewall 470 rises perpendicularly from the circumference 468 of the support surface. Together, the support surface 460 and the sidewall 470 form a recess 480. An end of the spring is seated in this recess.

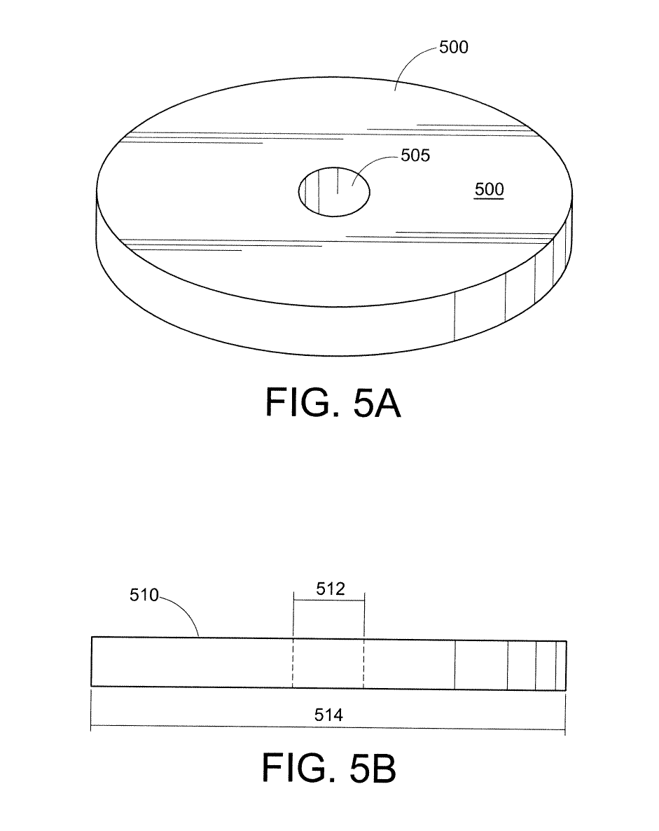

FIG. 5A and FIG. 5B are views of a sealing member. Here, the sealing member 500 is in the shape of a flat annular surface, i.e. a washer. The sealing member 500 has a support surface 510. The support surface is flat on at least one side, and usually on both sides. The support surface 510 has a diameter 514. A central aperture 505 is present in the support surface 510. The central aperture 505 also has a diameter 512. The sealing member is generally made from a flexible material that is resistant to wear or degradation from the fluid. An exemplary material from which the sealing member can be made is a fluorocarbon, such as VITON. The flexibility is desired to ensure a better seal around the edge of the outlet aperture of the hub, compared to a rigid material. The sealing member is sized to close the outlet aperture 152 of the hub, or more generally the central passageway or central bore of the hub (see FIG. 1).

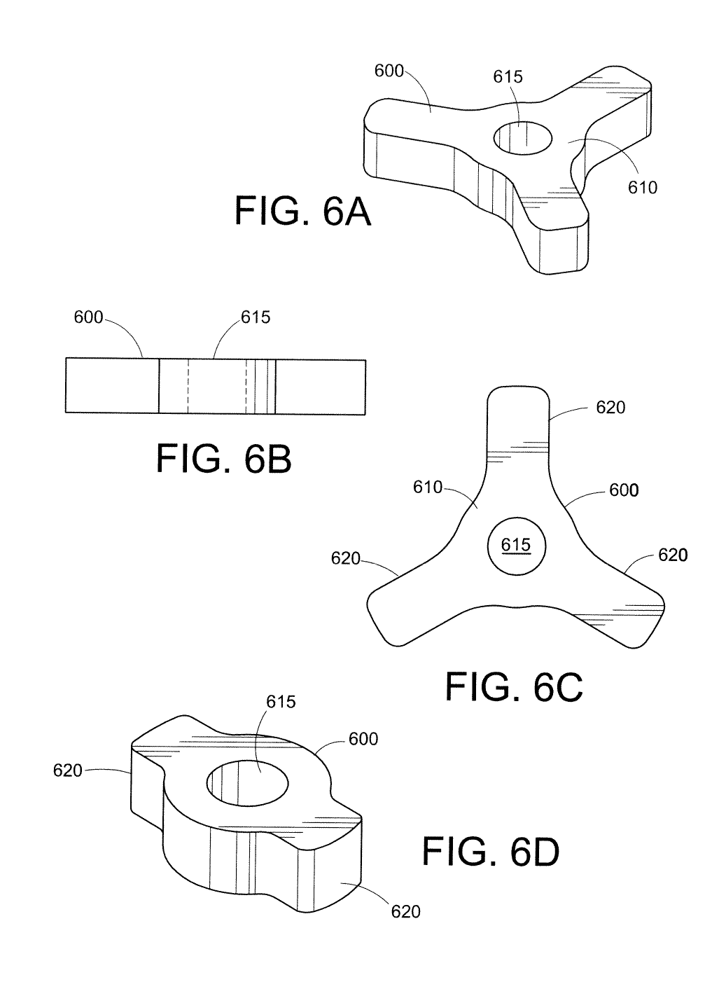

FIGS. 6A-6D are views of exemplary embodiments of an upper support member 600. Generally speaking, the upper support member is used to hold the components of the pressure relief valve against the hub. The upper support member 600 includes a core 610. The core 610 includes a central aperture 615. A plurality of legs 620 extends radially away from the core 610. The number of legs is not important. For example, FIG. 6A shows an embodiment with three legs and FIG. 6D shows an embodiment with two legs. The legs 620, whatever their number, are generally spaced evenly about the circumference of the core 610, so that the upper support member will not fall through the central passageway 210 of the hub 200 when the bypass valve assembly is being put together (see FIG. 2A).

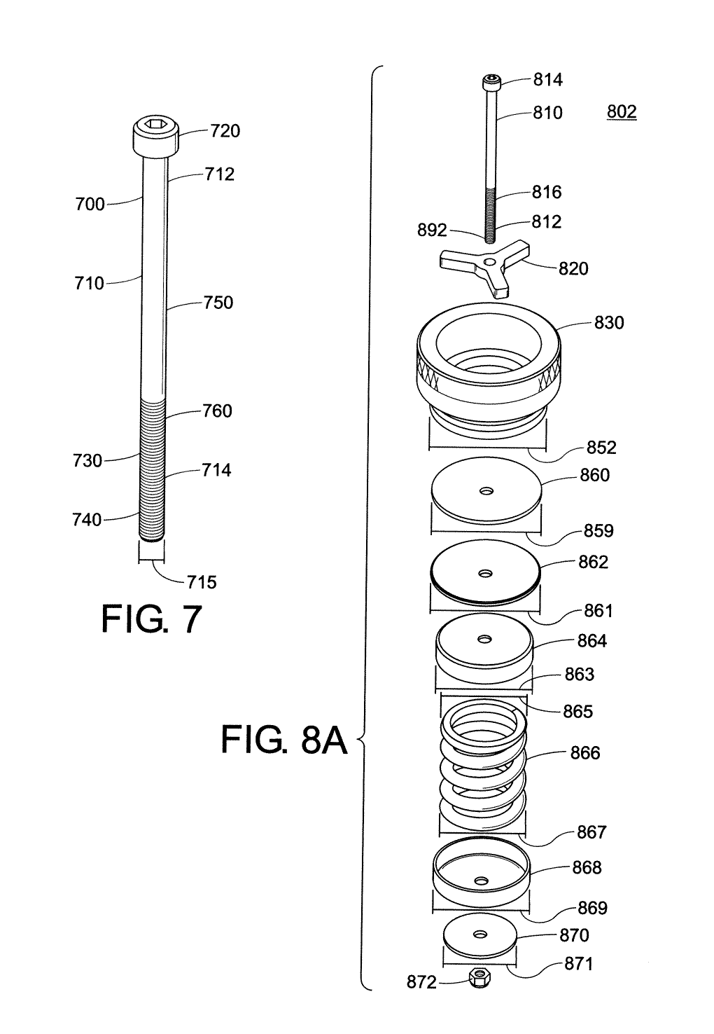

FIG. 7 is a perspective view of an exemplary embodiment of a pin, which is used to bind the various components of the pressure relief valve together. The pin 700 has a shank 710 with a first end 712 and a second end 714. A pin head 720 is on the first end 712, while a thread 730 is on the second end 714. The second end 714 can also be considered a pin end 740 with an external thread. The shank 710 includes a non-threaded portion 750 between the head 720 and the thread 730. Alternatively, the shank 710 can be considered as having a non-threaded portion 750 and a threaded portion 760. Referring to FIG. 5A, the non-threaded portion 750 of the pin shank 710 passes through the central aperture 505 of the sealing member 500. Indeed, the diameter 715 of the shank is generally sized to be just greater than the diameter 512 of the central aperture 505, to ensure a tight seal between the pin and the sealing member as well. The pin shown here is also referred to as a socket head cap screw.

Referring now to FIG. 2B, FIG. 3, FIG. 4B, FIG. 4D, and FIG. 5B, in embodiments, the diameter 312 of the upper end of the spring 300 is between the inner diameter 242 and the outer diameter 244 of the lower portion of the hub 200. In addition, in particular embodiments the diameter 312 of the upper end of the spring 300 is substantially equal to the diameter 514 of the sealing member 500. This congruence ensures that the circumference of the sealing member forms a tight seal around the outlet aperture of the hub. The diameter 322 of the lower end of the spring 300 is less than or equal to the diameter 414, 464 of the spring support member (i.e. the diameter of the support surface), to provide a surface against which the spring pushes to form the seal on the hub. In particular embodiments, the spring support member is a spring cup as depicted in FIG. 4C, with the lower end 320 of the spring being seated in the recess 480.

In additional embodiments, the spring support member is a spring cup, and a lower washer like that depicted in FIG. 4A is located on the side of the spring support member opposite the recess, i.e. the lower washer is located between the spring support member and the nut, or the lower washer is located opposite the lower end of the spring.

In other embodiments, an upper washer is located between the sealing member and the upper end of the spring, adjacent to the sealing member. The diameter of the upper washer is substantially equal to the diameter of the sealing member. Alternatively, in some embodiments, a upper spring cup as depicted in FIG. 4C is located between the sealing member and the spring. The upper end of the spring seats in the recess of the upper spring cup. It may be desirable to put these additional component(s) between the sealing member and the spring, to reduce the possibility of the spring puncturing the sealing member and circumventing the sealing function. In embodiments, the diameter of the upper spring cup will be greater than the inner diameter of the lower portion of the hub. Both the upper washer and the upper spring cup may be used together as well.

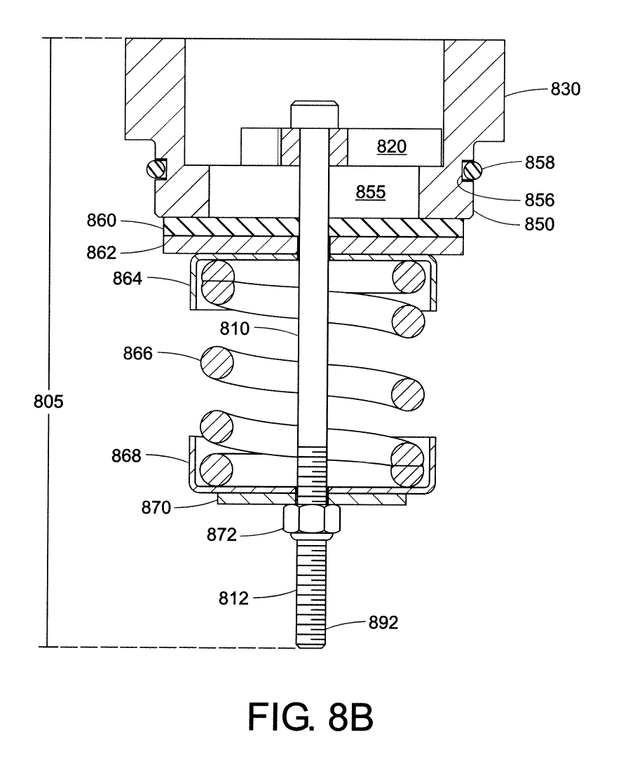

FIG. 8A is an exploded view of a second exemplary embodiment of a bypass valve assembly of the present disclosure, illustrating these various aspects in one embodiment. This depiction should not be construed as requiring that all of the aspects must be present together. The bypass valve assembly 802 is shown here from top to bottom as consisting essentially of a pin 810, an upper support member 820, a hub 830, a sealing member 860, an upper washer 862, an upper spring cup 864, a spring 866, a lower spring cup 868, a lower washer 870, and a nut 872. The nut shown here is also referred to as a nylon lock washer nut.

As seen here, the diameter 859 of the sealing member 860 is sized to close the outlet aperture of the hub 830. Put another way, the sealing member diameter 859 is greater than a diameter of the outlet aperture. The diameter of the outlet aperture is the same as the inner diameter of the lower portion of the hub. The diameter 861 of the upper washer 862 is substantially equal to the diameter 859 of the sealing member 860. The upper spring cup 864 has a recess into which the upper end of the spring 866 is seated. The lower spring cup 868 also has a recess into which the lower end of the spring 866 is seated.

The sealing member 860 is adjacent to the lower portion 850 of the hub 830. The upper washer 862 is adjacent to the sealing member 860. The upper spring cup 864 is adjacent to the upper washer 862, or in other words the upper washer 862 is located between the sealing member 860 and the upper spring cup 864. The spring 866 is located between and contacts both the upper spring cup 864 and the lower spring cup 868. The shank of the pin 810 passes sequentially through the upper support member central aperture, the sealing member central aperture, the upper washer central aperture, the upper spring cup central aperture, the spring, the lower spring cup central aperture, and the lower washer central aperture.

As is seen here, the sealing member diameter 859, upper washer diameter 861, upper spring cup diameter 863, spring upper end diameter 865, spring lower end diameter 867, lower spring cup diameter 869, and lower washer diameter 871 are each less than the outer diameter 852 of the lower portion of the hub. This fact allows these components to fit into the interior of a filter assembly, as will be explained further herein. In this embodiment of FIG. 8A, the sealing member 860, upper washer 862, upper spring cup 864, spring 866, lower spring cup 868, and lower washer 870 can be considered as forming the pressure relief element.

FIG. 8B is a side cross-sectional view of the bypass valve assembly 802 of FIG. 8A, in an assembled form. As can be seen here, the sealing member 860 is biased to close off the outlet aperture 855 of the hub, preventing fluid flow through the outlet aperture until a pressure differential is sufficient to push the spring 866 down. The pin end 812 of the pin 810 extends beyond the nut 872, and acts as the first rotary complementary joining mechanism 892. An o-ring 858 is also located in an annular recess 856 on the exterior surface of the lower portion 850 of the hub 830. The bypass valve assembly 802 has a length 805 measured from the top of the hub to the bottom of the pin end 812.

It should be noted that although the head 814 of the pin is shown adjacent to the upper support member 820 and the nut 872 is adjacent to the lower washer 870, the pin can be reversed, so that the threaded portion 816 of the pin is adjacent to the upper support member 820 along with the nut 872 and the head 814 of the pin is adjacent to the lower washer 870. However, this orientation of the pin would not provide a rotary complementary joining mechanism.

The various parts of the bypass valve assembly are shown as generally having a circular shape. This circular shape of each part itself is not required, as long as the part can fulfill its function. For example, the upper spring cup secures the spring relative to the pin and to the sealing member by seating the upper end of the spring in a recess. The upper spring cup itself does not need to be circular, as long as the upper end of the spring can be seated. For example, rather than being a circular shape with a diameter, the upper spring cup could have the shape of a square, with the length of each side being equal to the diameter of the circular shape. Generally, however, a circular shape for each part is more desirable.

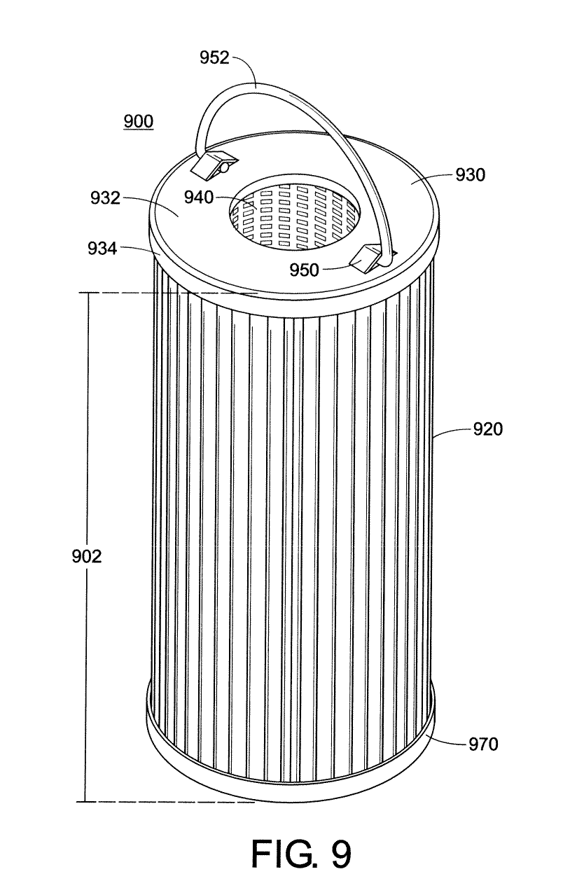

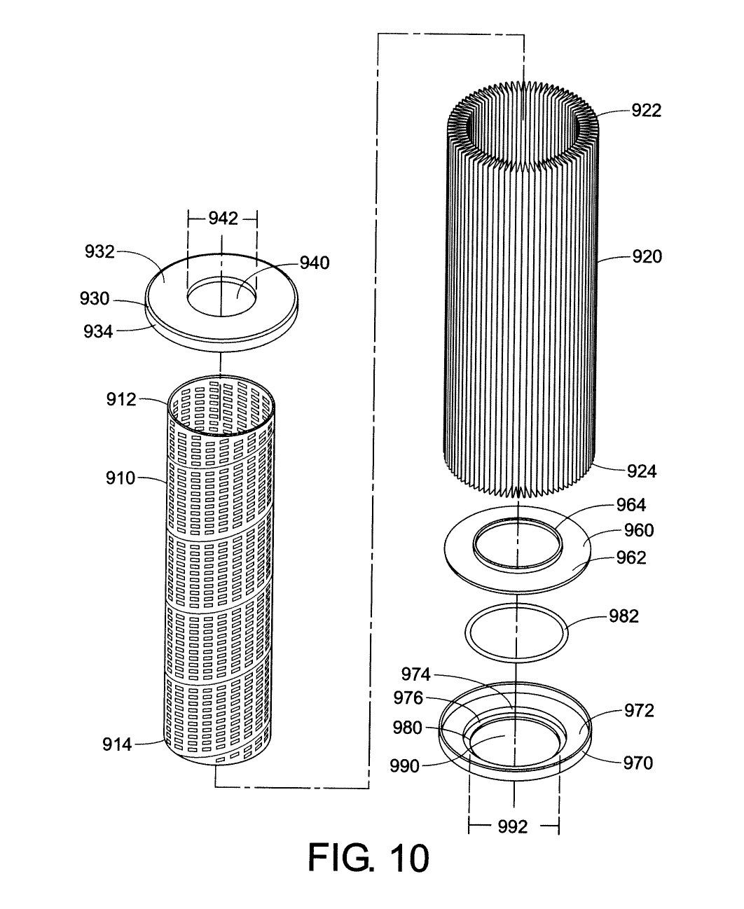

The bypass valve assembly is intended to be used with an outer filter assembly. FIG. 9 is a perspective view of an outer filter assembly, and FIG. 10 is an exploded cross-sectional view showing the various parts of the outer filter assembly.

The filter assembly 900 is constructed around a perforated tube 910. The perforated tube 910 has a first open end 912 and a second open end 914. An annular filter element 920 surrounds the perforated tube 910. The annular filter element 920 also has a first end 922 and a second end 924. The first end 912 of the perforated tube and the first end 922 of the annular filter element are at the same end of the filter assembly. A first end cap 930 is attached to the first end 922 of the annular filter element, as well as the first end 912 of the perforated tube. The first end cap 930 has an annular surface 932 and a central sidewall 934. The central sidewall 934 can extend into the first end 912 of the perforated tube. This first end cap 930 can also be considered as being on the top end or upper end of the filter assembly. The first end cap 930 defines a first opening 940 in the filter assembly. Two catches 950 are present on the first end cap, along with a handle 952 that engages the two catches. The first end cap is usually bonded to the annular filter element using a single-component epoxy resin that can be heat cured.

Two different components are used at the second end. A flange 960 is attached to the second end 924 of the annular filter element, as well as the second end 914 of the perforated tube. The flange 960 comprises an annular surface 962 and a central sidewall 964. Attached to the flange 960 is an end cover 970. The end cover 970 comprises an annular surface 972, a central sidewall 974, and a lip 976. The central sidewall 974 extends perpendicularly from the annular surface 972. The lip 976 extends inwards from the other end of the central sidewall 974. Together, the flange 960 and the end cover 970 define an annular recess 980 into which an o-ring (not shown) can be inserted. The flange 960 and the end cover 970 also cooperate to define a second opening 990. The diameter 942 of the first opening 940 is less than the diameter 992 of the second opening 990. The filter assembly has a length 902 measured from the first end cap 930 to the end cover 970. The flange and the end cover are usually bonded to the annular filter element using a single-component epoxy resin, like the first end cap.

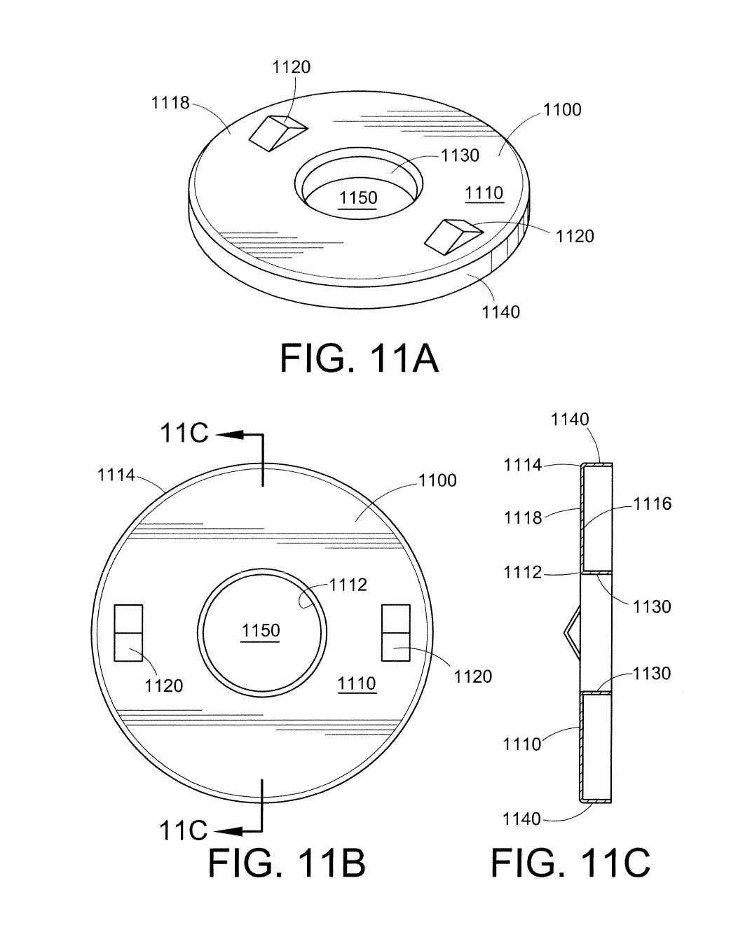

FIGS. 11A-11C are various views of an exemplary embodiment of a first end cap 1100 securing one end of the filter assembly. The annular surface 1110 has an interior face 1116 and an exterior face 1118 on opposite sides of the annular surface. Two handle catches 1120 are visible on the exterior face 1118. The annular surface 1110 has an inner perimeter 1112 and an outer perimeter 1114. The central sidewall 1130 extends axially from the interior face 1116 along the inner perimeter 1112. An outer sidewall 1140 extends axially from the interior face 1116 along the outer perimeter 1114. The annular filter element and the perforated tube are located between the central sidewall 1130 and the outer sidewall 1140. The first end cap 1100 will define a first opening 1150 of the filter assembly.

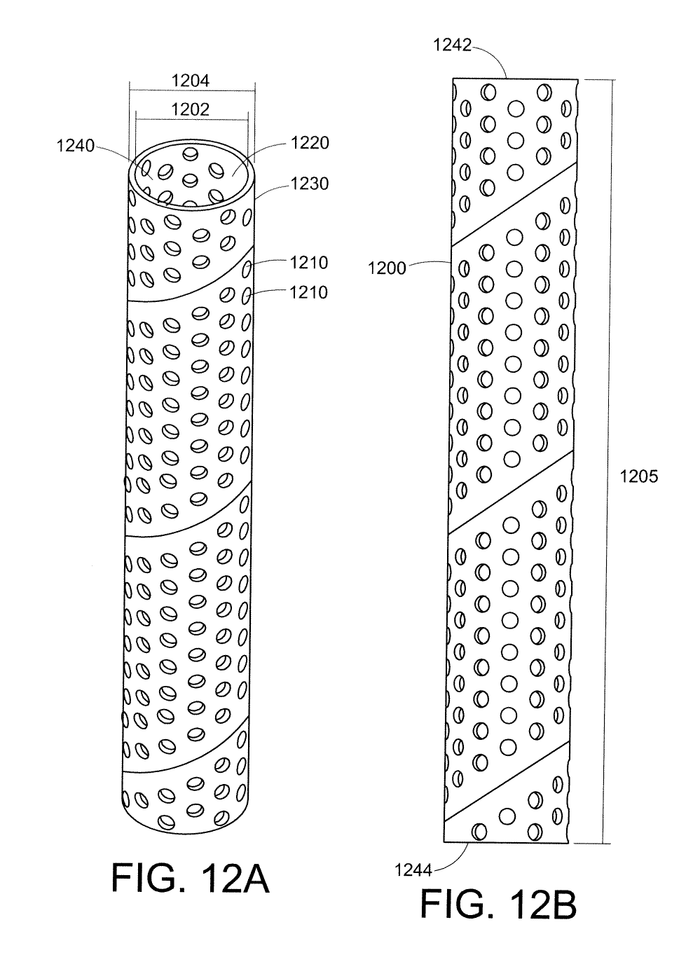

FIG. 12A and FIG. 12B are views of an exemplary embodiment of a perforated tube 1200. The perforations 1210 in FIG. 12A are circular, and spiral around the surface of the tube. The perforated tube 1200 has a length 1205, an inner diameter 1202, and an outer diameter 1204. The perforations 1210 pass directly from the outer side 1230 of the tube to the inner side 1220. The perforated tube 1200 includes a central bore 1240 extending between a first open end 1242 and a second open end 1244.

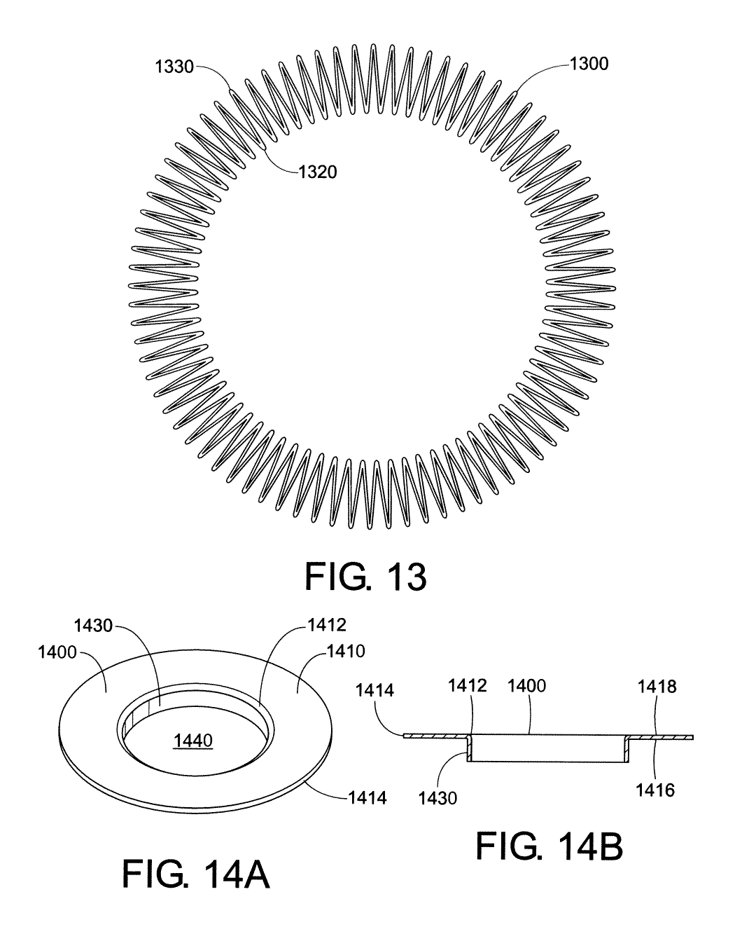

FIG. 13 is a top view of an annular filter element or annular filter medium 1300. As seen here, the filter element can be pleated. The pleats extend axially along the length of the perforated tube, and extend radially. This results in an inner side 1320 and an outer side 1330 of the annular filter element.

FIG. 14A and FIG. 14B show a first exemplary embodiment of a flange 1400 to be used at one end of the perforated tube along with an end cover. The flange 1400 has an annular surface 1410 with an inner perimeter 1412 and an outer perimeter 1414. The annular surface 1410 also has an interior face 1416 and an exterior face 1418 on opposite sides of the annular surface. A central sidewall 1430 extends axially from the interior face 1416 along the inner perimeter 1412. The central sidewall 1430 surrounds a central bore 1440 that runs between the interior face 1416 and the exterior face 1418.

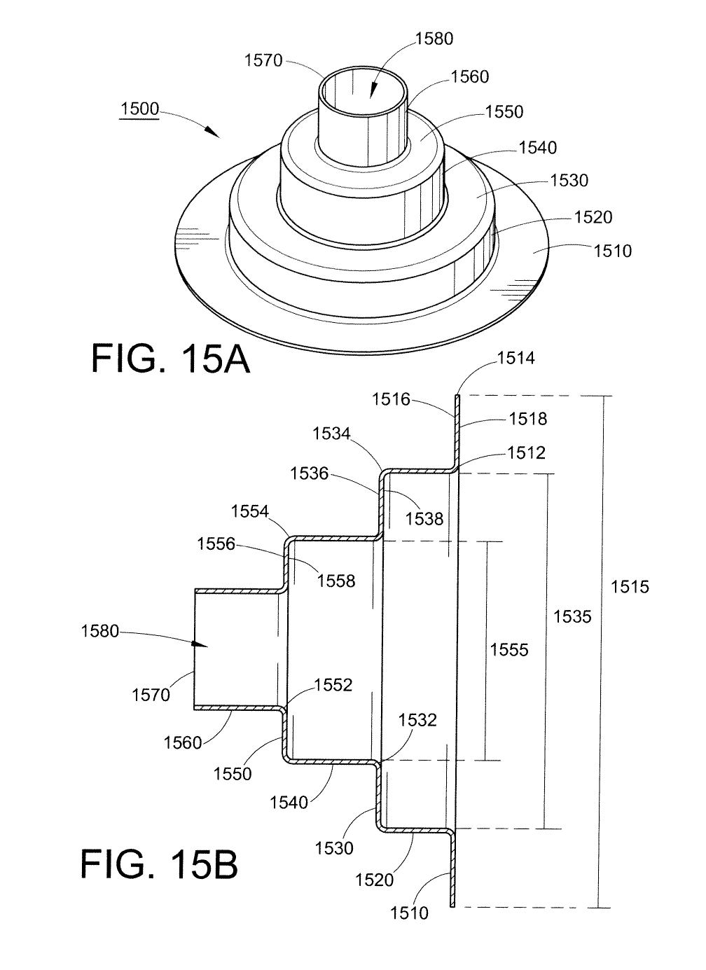

FIG. 15A and FIG. 15B show a second exemplary embodiment of a flange. The flange 1500 includes a first annular surface 1510 with an inner perimeter 1512 and an outer perimeter 1514. The first annular surface 1510 also has an interior face 1516 and an exterior face 1518 on opposite sides of the annular surface. A first central sidewall 1520 extends axially from the interior face 1516 along the inner perimeter 1512 of the first annular surface 1510. A second annular surface 1530 extends inwards from the opposite end of the first central sidewall 1520. The second annular surface 1530 also has an interior face 1536 and an exterior face 1538 on opposite sides. The opposite end of the first central sidewall 1520 is along the outer perimeter 1534 of the second annular surface. A second central sidewall 1540 extends axially from the inner perimeter 1532 of the second annular surface 1530. A third annular surface 1550 extends inwards from the opposite end of the second central sidewall 1540. The third annular surface 1550 also has an interior face 1556 and an exterior face 1558 on opposite sides. The opposite end of the second central sidewall 1540 is along the outer perimeter 1554 of the third annular surface 1550. A third central sidewall 1560 extends axially from the inner perimeter 1552 of the third annular surface and defines an interior end 1570 of the flange. The resulting flange 1500, as seen in FIG. 15B, resembles a stepped pyramid. A central bore 1580 extends from the exterior face 1518 of the first annular surface to the interior end 1570. The outer diameter 1515 of the first annular surface is greater than the outer diameter 1535 of the second annular surface, and the outer diameter 1535 of the second annular surface is greater than the outer diameter 1555 of the third annular surface.

Moving from the interior end down to the first annular surface, the third annular surface 1550 may also be referred to as the primary annular surface. The third central sidewall 1560 may also be referred to as the primary central sidewall. The second annular surface 1530 may also be referred to as the secondary annular surface. The second central sidewall 1540 may also be referred to as the secondary central sidewall. The first annular surface 1510 may also be referred to as the tertiary annular surface. The first central sidewall 1520 may also be referred to as the tertiary central sidewall.

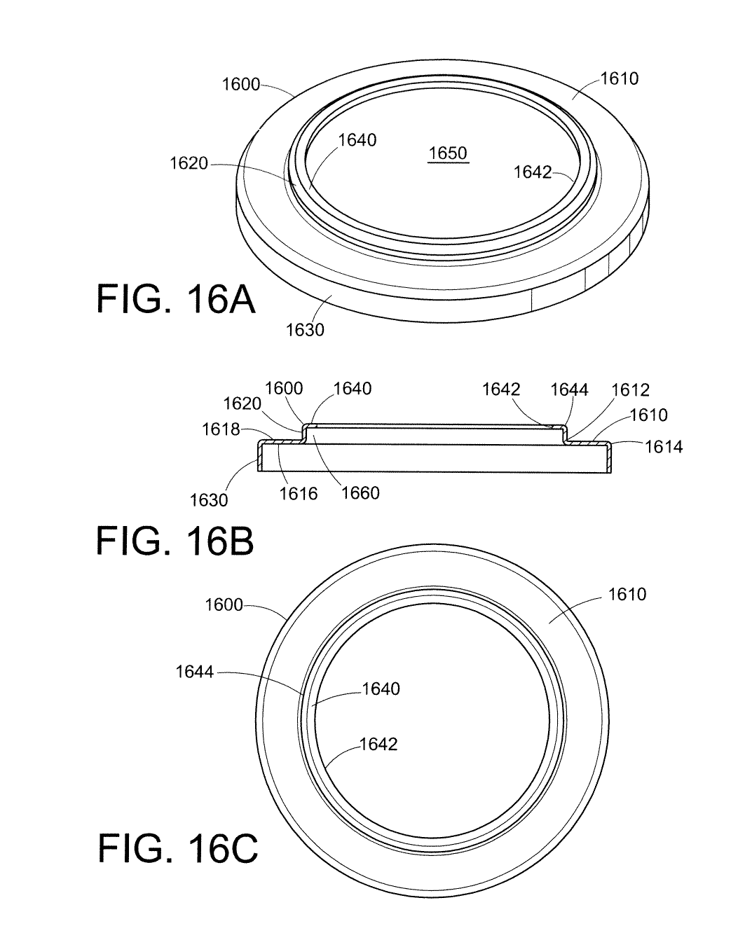

FIGS. 16A-16C are views of an end cover that is used in conjunction with the flange to cover the second end of the filter assembly. The end cover 1600 comprises an annular surface 1610 with an inner perimeter 1612 and an outer perimeter 1614. The annular surface 1610 also has an interior face 1616 and an exterior face 1618 on opposite sides of the annular surface. A central sidewall 1620 extends axially from the exterior face 1618 along the inner perimeter 1612 of the annular surface. Another annular surface, also referred to herein as a lip 1640, extends inwards from the opposite end of the central sidewall and forms an inner perimeter 1642. The opposite end of the central sidewall is along the outer perimeter of the lip 1644. An outer sidewall 1630 extends axially from the interior face 1616 along the outer perimeter 1614 of the annular surface 1610. A central bore 1650 extends through the end cover 1600. The central bore 1650 has a diameter 1652, and the circumference of the central bore is the inner perimeter 1642 of the lip.

Together, the flange and the end cover form a second end cap. Referring to FIG. 14A and FIG. 16A, the exterior face 1418 of the flange 1400 is adjacent the interior face 1616 of the end cover 1600, and together they define a second opening. It should also be noted that the lip 1640 and the central sidewall 1620 of the end cover 1600, together with the exterior face 1418 of the flange, form an annular recess 1660 in which an o-ring can be placed. Of course, it is contemplated that a one-piece second end cap, essentially combining the flange and the end cover together, could also be used.

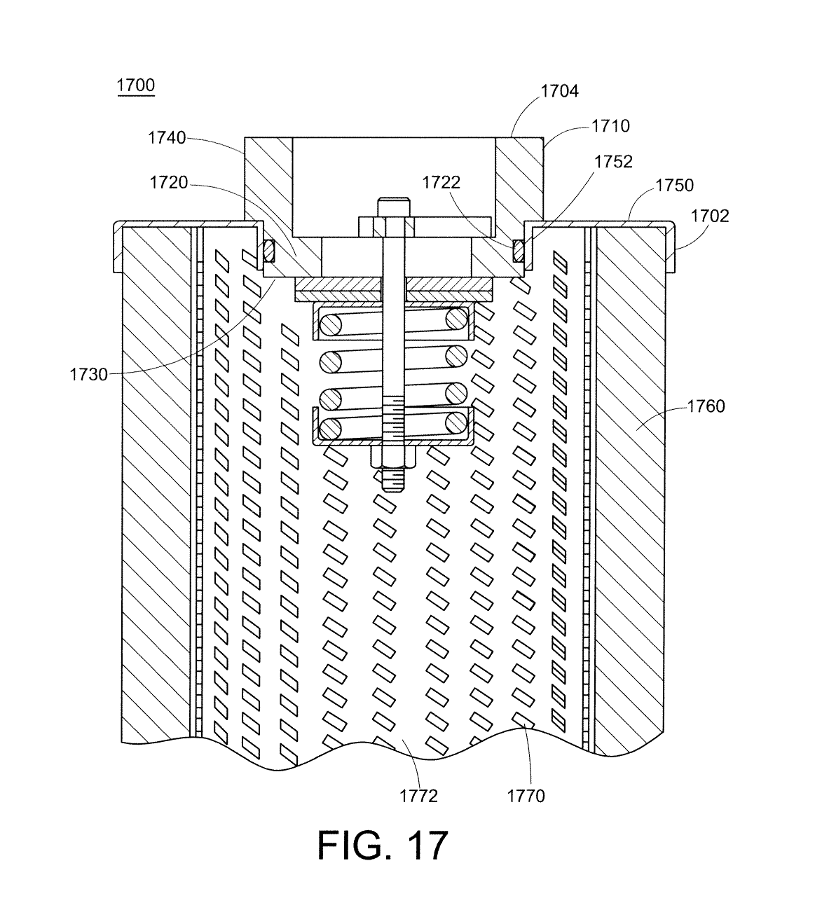

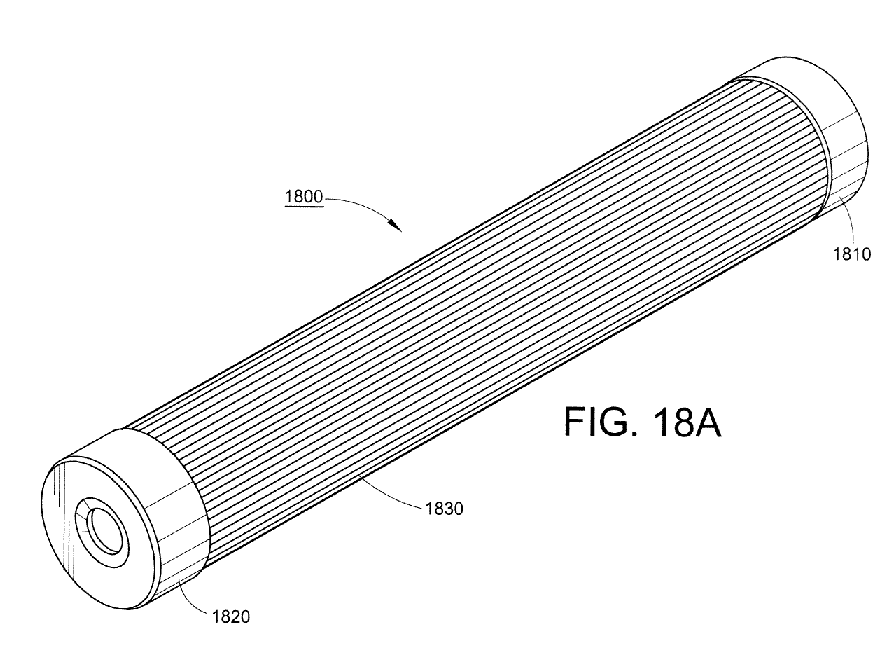

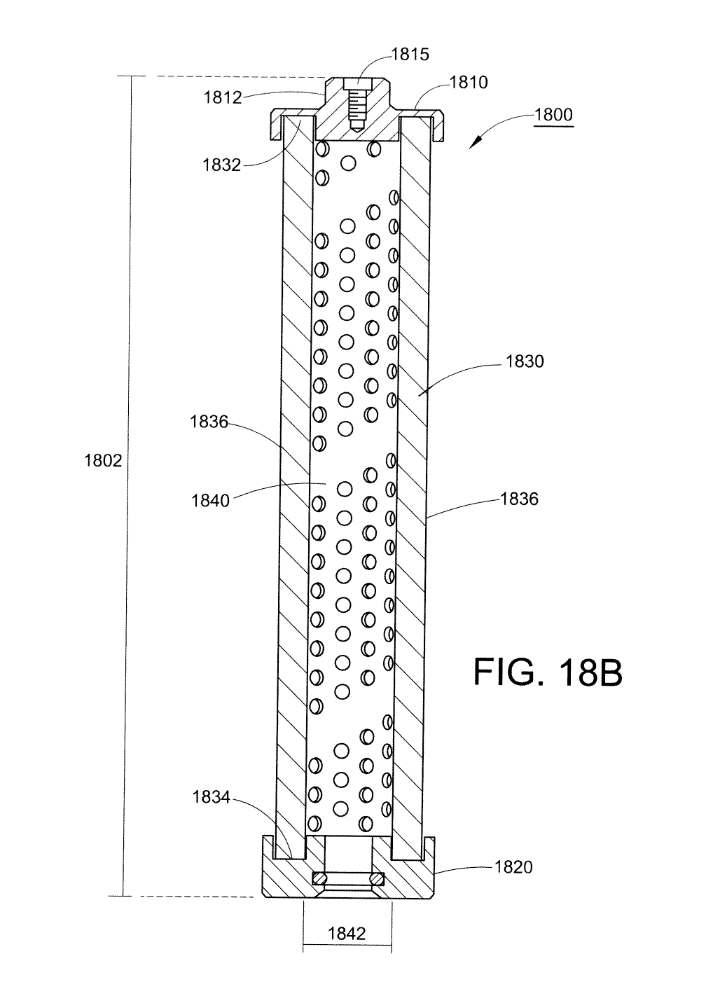

FIG. 17 is a side cross-sectional view of a recyclable filter element. The recyclable filter element 1700 comprises a filter assembly 1702 and a bypass valve assembly 1704. As seen here, the lower portion 1720 of the bypass valve assembly hub 1710 fits into the first opening 1730 of the filter assembly and makes a sealing engagement with the first opening. In this regard, the o-ring 1722 on the exterior surface of the lower portion 1720 of the hub 1710 makes a sealing engagement with the central sidewall 1752 of the first end cap 1750. Put another way, the diameter of the first opening 1730 is approximately equal to the outer diameter of the lower portion 1720 of the hub. The upper portion 1740 of the bypass valve assembly hub 1710 sits on the first end cap 1750. Put another way, the outer diameter of the upper portion 1740 of the hub is greater than the diameter of the first opening 1750.

The lower portion 1720 of the bypass valve assembly is unable to make a sealing engagement with the second opening of the filter assembly. In this regard, please note that the first opening 1730 of the filter assembly does not have an o-ring, while the second opening of the filter assembly does have an o-ring. This imparts directionality to the filter assembly, i.e. the first opening is the top end or upper end of the filter assembly. In particular embodiments, the diameter of the second opening of the filter assembly is greater than the outer diameter of the upper portion of the hub.

It should be noted that the perforations 1770 of the perforated tube 1772 shown in FIG. 17 are rectangular. The perforations also alternate in direction. Half of the perforations point towards the first open end and the first opening 1730, while the other half point towards the second open end of the tube as they spiral around the tube. An annular filter element 1760 surrounds the perforated tube.

The bypass valve assembly can be connected to an inner filter assembly. FIG. 18A is a perspective view of the inner filter assembly, and FIG. 18B is a side cross-sectional view of the inner filter assembly. As seen in these filters, the inner filter assembly 1800 includes a first closed end cap 1810 and a second end cap 1820. An inner element 1830 is present which has a first end 1832 and a second end 1834. The inner element 1830 is shown here as having an annular shape and surrounding a perforated tube 1840 having a diameter 1842. While the inner element is not always annular and may have different exterior shapes, the inner element 1830 can be considered as having an imaginary outermost cylindrical surface 1836. The first closed end cap 1810 is attached to the first end 1832 of the inner element, and the second end cap 1820 is attached to the second end 1834 of the inner element. Generally speaking, the central core 1812 of the first closed end cap 1810 includes a second rotary complementary joining mechanism 1815. This allows the inner filter assembly to be joined or connected to the bypass valve assembly. The inner filter assembly 1800 has a length 1802 measured from the top of the first closed end cap to the bottom of the second end cap.

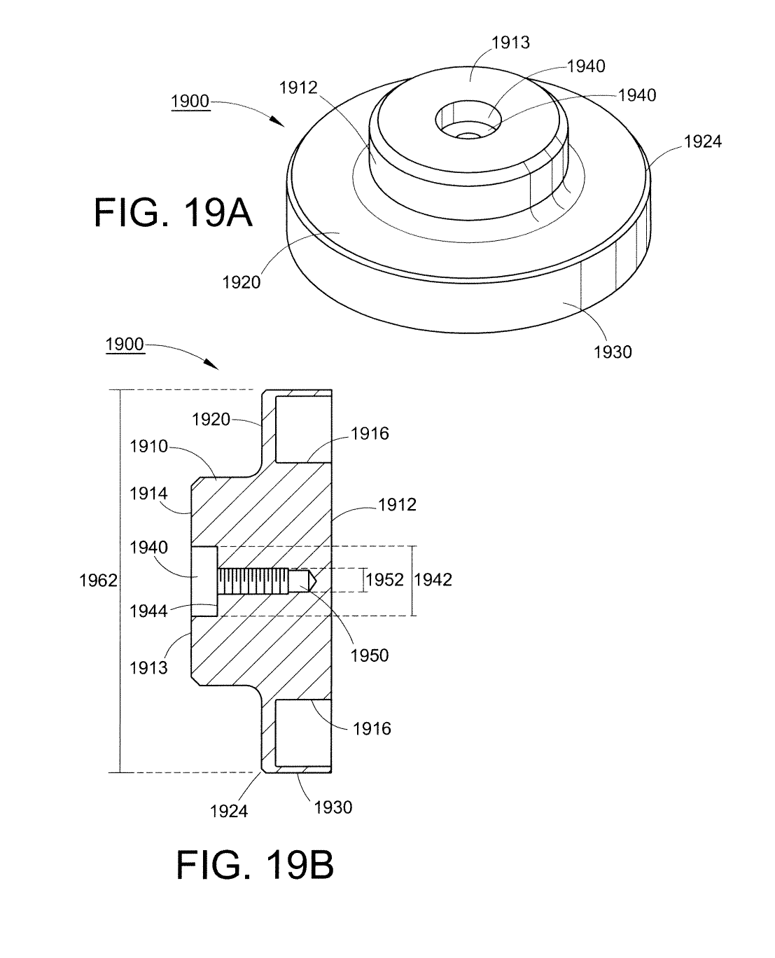

FIGS. 19A-19C are views of the first closed end cap. In embodiments, the first closed end cap 1900 comprises a central core 1910. The central core 1910 has an outer end 1914 with an external surface 1913 and an inner end 1912. An annular surface 1920 extends axially from the central core 1910. An outer sidewall 1930 extends axially from an outer perimeter 1924 of the annular surface 1920 towards the inner end 1912. An inner surface 1916 of the central core is located between the annular surface 1920 and the inner end 1912. A second rotary complementary joining mechanism is present on the outer end of the central core. As shown here, a cavity 1940 runs from the outer end 1914 into the central core 1910 and terminates at a cavity surface 1944 located within the central core. An internal threaded recess 1950 then runs from the cavity surface 1944 into the central core 1910 towards the inner end 1912. The diameter 1942 of the cavity is greater than the diameter 1952 of the internal threaded recess. Here, the internal threaded recess is the second rotary complementary joining mechanism. The first closed end cap has a diameter 1962 that is the same as the diameter of the annular surface 1920.

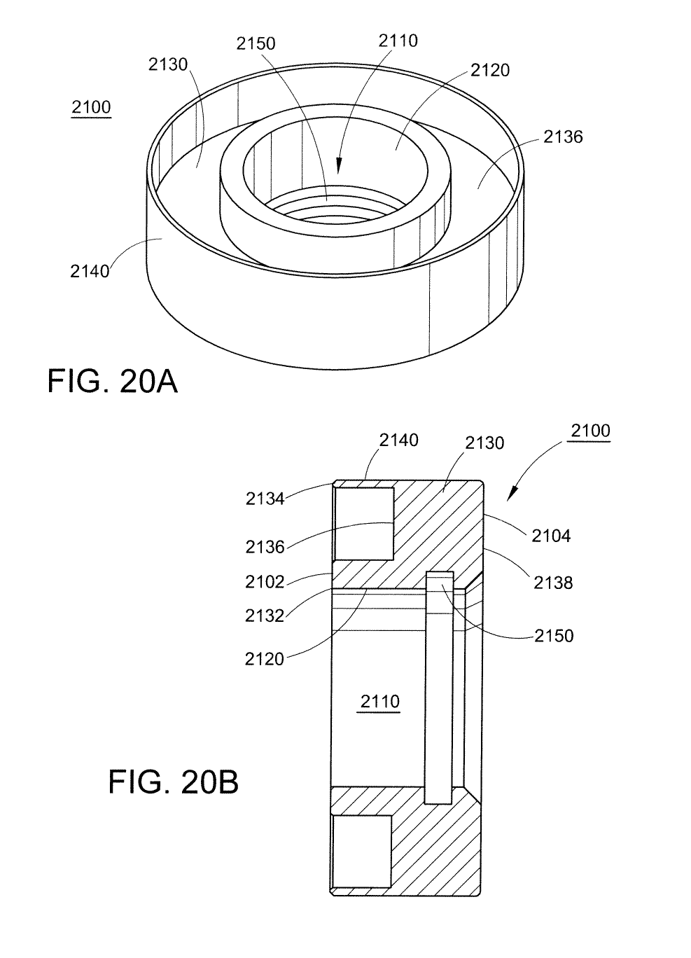

FIG. 20A and FIG. 20B are views of an exemplary embodiment of a second end cap 2100. This embodiment is an open end cap, i.e. a central bore 2110 is surrounded by a central sidewall 2120. The second end cap 2100 has an inner end 2102 and an outer end 2104. An annular ring 2130 has an inner perimeter 2132 and an outer perimeter 2134. The annular ring 2130 also has an interior face 2136 and an exterior face 2138 on opposite sides. An outer sidewall 2140 extends axially from the outer perimeter 2134 towards the inner end 2102, or in other words from the interior face 2136. The central sidewall 2120 extends axially from the inner perimeter 2132 towards the inner end 2102, or in other words from the interior face 2136. An annular recess 2150 is also provided in the central bore 2110 for an o-ring (not shown).

The inner element includes a perforated tube defining the central bore, like the perforated tube of FIGS. 12A-12C. An annular element surrounds the perforated tube. The annular element permits flow of the fluid or liquid through a porous outer sidewall through the annular element and into the central bore of the perforated tube. The central bore of the annular tube is axially aligned with the central bore of the second end cap. An annular housing is defined by the outer sidewall, the perforated tube, the first closed end cap, and the second end cap. In some embodiments, the annular housing is an annular pleated filter, like that shown in FIG. 13. In other embodiments, rather than being a pleated filter, the annular housing contains an agent that interacts with the fluid to accomplish a given task. For example, the agent can be a magnetic material that attracts and retains magnetic debris in the fluid, such as iron or nickel particles. As another example, the agent can be a dessicant to remove water from lubricating oils or fluids.

When the inner element is used with the closed end cap shown in FIG. 19A and with the second open end cap shown in FIG. 20A, the outer sidewall of the first closed end cap will extend over the outermost surface of the annular filter medium, as will the outer sidewall of the second end cap. The central bore of the second end cap will be axially aligned with the central bore of the perforated tube. The central core of the first closed end cap will extend into the first end of the perforated tube. The central sidewall of the second end cap will extend into the second end of the perforated tube. An embodiment of this first type of inner element is seen in FIG. 18A and FIG. 18B.

Another embodiment of an inner element is contemplated which comprises an inner core and a plurality of blades suitable for directing the flow of a fluid. In embodiments, the blades are arranged helically about a cylindrical inner core.

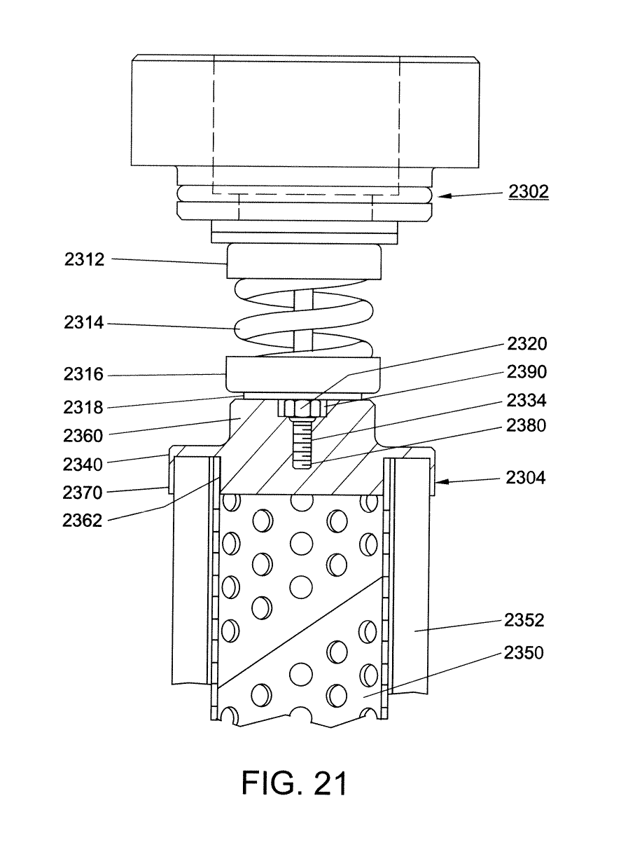

FIG. 21 is a side cross-sectional view showing how the bypass valve assembly 2302 and the inner filter assembly 2304 are connected to each other. The upper spring cup 2312, spring 2314, lower spring cup 2316, lower washer 2318, nut 2320, and shank 2330 of the bypass valve assembly are shown. The first closed end cap 2340 of the inner filter assembly 2304 is shown, with the perforated tube 2350 and the annular filter element 2352 being located between the inner surface 2362 of the central core 2360 and the outer sidewall 2370 of the first closed end cap 2340. The second end of the shank, i.e. the pin end 2334, on the bypass valve assembly 2302 is inserted into the internal threaded recess 2380 of the central core of the first closed end cap of the inner filter assembly. Put another way, the external thread on the bypass valve assembly engages or is joined with the internal thread on the inner filter assembly. The nut 2320 fits in the cavity 2390 in the central core 2360 as well.

In general terms, the bypass valve assembly can be considered as comprising the hub, a pressure relief element, and a first joining mechanism. The pressure relief element is located between the hub and the first joining mechanism. Put another way, the first joining mechanism is on the end of the pressure relief element opposite the hub. The inner filter assembly comprises a first closed end cap, a second end cap, and an inner element between the first closed end cap and the second end cap. The central core of the first closed end cap has an inner end and an outer end. The outer end of the central core contains a second joining mechanism. The first joining mechanism on the bypass valve assembly and the second joining mechanism on the inner filter assembly are complementary to each other, and the connection that is formed is also a reversible connection. Because the inner filter assembly might come under axial pressure from fluid flowing through the bypass valve assembly, the joining mechanism should be one that requires radial motion. For example, an annular snap-fit mechanism could be used that uses one or more cantilevered hooks as one joining mechanism and an interrupted annular ring as the complementary joining mechanism (similar to the child-proof cap used on many pill bottles).

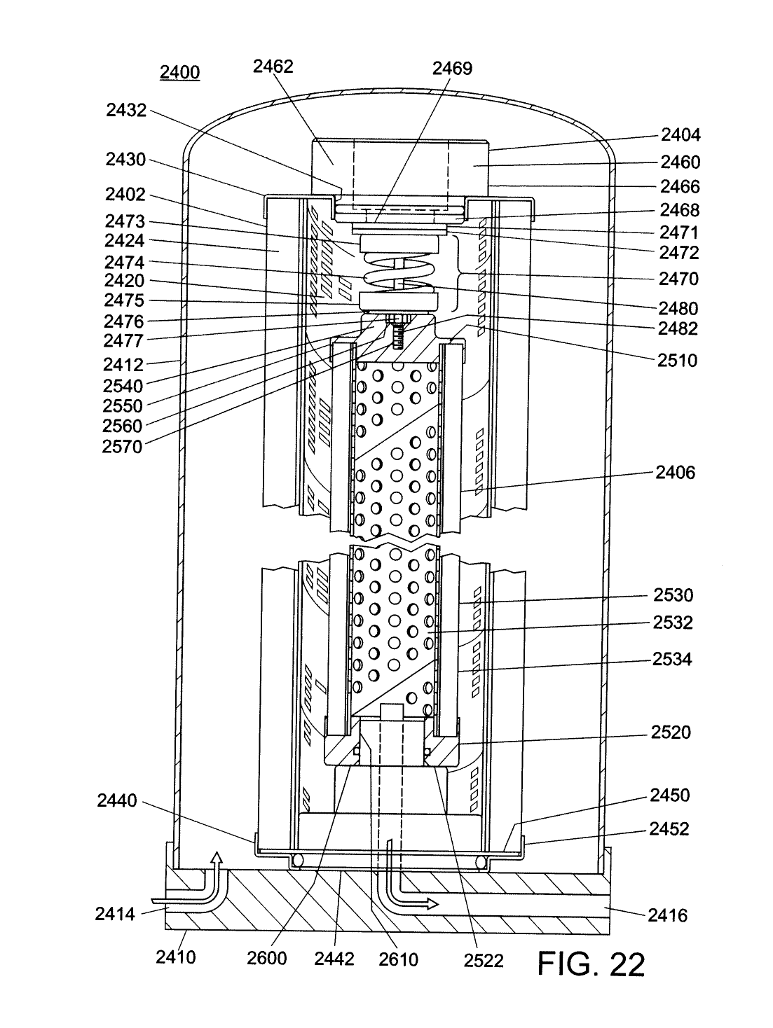

FIG. 22 is a side cross-sectional view showing a filter unit 2400 that comprises or consists of an outer filter assembly 2402, a bypass valve assembly 2404, and an inner filter assembly 2406. The filter unit 2400 is shown on a filter mount 2410 enclosed in a housing 2412 which is threaded onto the filter mount. A fluid inlet 2414 brings fluid into the housing 2412, between the housing wall and the outer filter assembly 2402. The fluid subsequently flows through the outer filter assembly 2402 and the inner filter assembly 2406. The fluid then exits the housing through a fluid outlet 2416. Put another way, the filter unit is an “outside-in” type.

The outer filter assembly 2402 includes a perforated tube 2420 defining a central bore. An annular filter medium 2424 surrounds the perforated tube 2420. The first end cap 2430 secures a first end of the perforated tube and the annular filter medium. A first opening 2432 is present in the first end cap. The second end cap 2440 secures a second end of the perforated tube and the annular filter medium. A second opening 2442 is present in the second end cap. It should be noted that here, the second end cap 2440 is shown as the combination of a flange 2450 and an end cover 2452.

The bypass valve assembly 2404 includes a hub 2460, a pressure relief element 2470, and a pin 2480. The hub 2460 comprises a sidewall 2462 which surrounds a central bore. The hub 2460 has an upper portion 2466 and a lower portion 2468, the two portions having different outer diameters as previously explained. An outlet aperture 2469 is present in the lower portion of the hub. The pressure relief element 2470 is adjacent the hub 2460 and acts to prevent flow of fluid through the outlet aperture until a predetermined pressure differential value is exceeded. As shown here, the pressure relief element 2460 is made up of a sealing member 2471, upper washer 2472, upper spring cup 2473, spring 2474, lower spring cup 2475, lower washer 2476, nut 2477, and pin 2480. (The upper support member suspending the pressure relief element from the hub is not visible.) A pin end 2482 is located on the end of the pressure relief element 2470 opposite the hub 2460. The pin end 2482 has an external thread. As shown here, the pin end 2482 is part of the pin 2480.

The inner filter assembly 2406 comprises a first closed end cap 2510, a second end cap 2520, and an inner element 2530. The cavity 2570 and internal threaded recess 2560 are visible in the central core 2540 of the first closed end cap 2510. The inner element 2530 is shown here as a perforated tube 2532 and an annular filter medium 2534. The perforated tube 2532 has a central bore. The outer sidewall 2550 of the first closed end cap 2510 extends over the outermost surface of the inner element 2530. The external thread on the pin end 2482 of the bypass valve assembly is joined with the internal threaded recess 2560 of the inner filter assembly 2406.

The bypass valve assembly 2404 and the inner filter assembly 2406 are located within the perforated tube 2420 of the outer filter assembly 2402. The lower portion 2468 of the hub of the bypass valve assembly is in sealing engagement with the first opening 2432 of the outer filter assembly.

One advantage of this construction is that the bypass valve assembly and the inner filter assembly can be separated from the outer filter assembly. As a result, the bypass valve assembly and the inner filter assembly can be reused when the outer filter assembly needs to be disposed of.

It should be noted that the second end cap 2520 of the inner filter assembly is in sealing engagement with a post that connects to the fluid outlet 2416 of the filter mount. As a result, fluid flows through both the outer filter assembly 2402 and the inner filter assembly 2406. In operation, the outer filter assembly usually has pores with a pore size smaller than the pore size of the inner filter assembly. For example, the pore size of the outer filter assembly is generally about 10 microns, whereas the pore size of the inner filter assembly is generally about 74 microns. As a result, the outer filter assembly is intended to capture the debris in the fluid circulating through the filter unit. In circumstances wherein the outer filter assembly is clogged or wherein the fluid is too viscous to flow through the small pores of the outer filter assembly, pressure will build up inside the filter mount housing until the bypass valve opens. The fluid can then bypass the outer filter assembly. The inner filter assembly then filters at least the larger-sized debris out of the fluid and allows the fluid to continue circulating until the outer filter assembly is replaced.

In FIG. 22, the outer filter assembly 2402 supports the inner filter assembly 2406. The second end cap 2520 of the inner filter assembly is constructed as seen in FIG. 20A, with an annular surface and a central bore. The second end cap 2440 of the outer filter assembly is constructed from a flange 2450 and an end cover 2452. The end cover is as shown in FIG. 16A. The flange is as shown in FIG. 15A, with a primary annular surface 2600 and a primary central sidewall 2610 extending axially into, and in sealing engagement with, the second end cap 2520 of the inner filter assembly. The annular surface 2522 of the second end cap 2520 of the inner filter assembly rests on the primary annular surface 2600 of the second end cap 2440 of the outer filter assembly.

As noted above, in FIG. 22 fluid must flow through both the outer filter assembly and the inner filter assembly before exiting the fluid outlet of the filter mount. However, embodiments are contemplated where fluid does not need to flow through the inner filter assembly. For example, in those embodiments where the inner filter assembly contains an agent that reacts with debris in the fluid, the fluid outlet 2416 of the filter mount 2410 is in sealing engagement with the second end cap 2440 of the outer filter assembly, not the second end cap 2520 of the inner filter assembly.

Several relationships exist between the outer filter assembly, the bypass valve assembly, and the inner filter assembly, and will be described with reference to FIG. 8B, FIG. 9, FIG. 18B, FIG. 19B, and FIG. 20B. The diameter 1962 of the first closed end cap of the inner filter assembly, the diameter of the inner element of the inner filter assembly, and the diameter 2102 of the second end cap of the inner filter assembly are each less than the diameter 942 of the first opening of the outer filter assembly. The length 1802 of the inner filter assembly and the length 805 of the bypass valve assembly are each less than the length 902 of the outer filter assembly. When the bypass valve assembly and the inner filter assembly are joined together, the length from the upper portion of the hub to the second end cap of the inner filter assembly is also less than the length of the outer filter assembly.

Again, the bypass valve assembly 2404 will only form a sealing engagement with the first opening 2432 of the outer filter assembly, and not with the second opening 2442 of the outer filter assembly. In embodiments, referring to FIG. 2B and FIG. 10, the outer diameter 234 of the upper portion of the hub is less than the diameter 992 of the second opening of the outer filter assembly.

Generally, the various parts of the outer filter assembly, bypass valve assembly, and the inner filter assembly (other than the filter elements) are made from stainless steel.

The devices of the present disclosure have been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. An inner filter assembly, comprising:
a first closed end cap comprising a central core having an outer end and an inner end, an annular surface extending radially from the central core, and an outer sidewall extending axially from an outer perimeter of the annular surface towards the inner end, the central core containing a cavity running from the outer end to a cavity surface, and an internal threaded recess running from the cavity surface towards the inner end;
a second end cap, and an outer sidewall extending axially from the outer perimeter towards the inner end; and
an inner element having a first end, a second end, an inner element diameter, and an imaginary outermost cylindrical surface, the inner element diameter being less than or equal to both a diameter of the first closed end cap and a diameter of the second end cap;
wherein the first closed end cap is attached to the first end of the inner element, the first closed end cap outer sidewall extending over the imaginary outermost cylindrical surface of the inner element; and
wherein the second end cap is attached to the second end of the inner element.

2. The inner filter assembly of claim 1, wherein the second end cap is an open end cap comprising an inner end, an outer end, an annular ring having an inner perimeter and an outer perimeter, an outer sidewall extending axially from the outer perimeter towards the inner end, and a central sidewall extending axially from the inner perimeter towards the inner end, the central sidewall surrounding a central bore.

3. The inner filter assembly of claim 2, wherein the inner element further comprises:
a perforated tube defining a central bore; and
an annular element surrounding the perforated tube, the annular element permitting flow of an associated liquid through the annular element into the central bore of the perforated tube;
wherein the central bore of the second end cap is axially aligned with the central bore of the perforated tube.

4. The inner filter assembly of claim 3, wherein the annular element further comprises a porous outer sidewall, and an annular housing is defined by the outer sidewall, the perforated tube, the first closed end cap, and the second end cap.

5. The inner filter assembly of claim 4, wherein the annular housing contains a magnetic material.

6. The inner filter assembly of claim 4, wherein the annular housing contains a dessicant.

7. The inner filter assembly of claim 3, wherein the annular element is a pleated filter element.

8. The inner filter assembly of claim 2, wherein the central sidewall includes an annular recess, and an o-ring is located inside the annular recess.

9. The inner filter assembly of claim 1, wherein the inner element further comprises an inner core and a plurality of blades suitable for directing the flow of a liquid.

10. The inner filter assembly of claim 9, wherein the blades are arranged helically about the inner core.

11. A combination for placing an inner filter assembly within an outer filter assembly, comprising:
an inner filter assembly and a bypass valve assembly;
wherein the inner filter assembly comprises:
a first closed end cap comprising a central core having an outer end and an inner end, an annular surface extending radially from the central core, and an outer sidewall extending axially from an outer perimeter of the annular surface towards the inner end, the central core containing a cavity running from the outer end to a cavity surface, and an internal threaded recess running from the cavity surface towards the inner end;
a second end cap; and
an inner element having a first end and a second end;
wherein the first closed end cap is attached to the first end of the inner element, the first closed end cap outer sidewall extending over an outermost surface of the inner element; and
wherein the second end cap is attached to the second end of the inner element; and
wherein the bypass valve assembly comprises:
a hub comprising a sidewall surrounding a central bore, an upper portion, a lower portion, and an outlet aperture in the lower portion;
a pressure relief element adjacent the hub and acting to prevent flow through the outlet aperture until a pressure differential value is exceeded; and
a pin end having an external thread, the pin end extending axially from an end of the pressure relief element opposite the hub;
wherein the external thread of the bypass valve assembly is joined with the internal threaded recess of the inner filter assembly to form the combination.

12. The combination of claim 11,
wherein the inner element of the inner filter assembly further comprises:
a perforated tube having a central bore; and
an annular element surrounding the perforated tube, the annular element permitting flow of an associated liquid through the annular element into the central bore of the perforated tube;
wherein the second end cap comprises an inner end, an outer end, an annular ring having an inner perimeter and an outer perimeter, an outer sidewall extending axially from the outer perimeter towards the inner end, and a central sidewall extending axially from the inner perimeter towards the inner end, the central sidewall surrounding a central bore; and
wherein the central bore of the second end cap is axially aligned with the central bore of the perforated tube.

13. The combination of claim 11,
wherein the pressure relief element of the bypass valve assembly comprises:
a sealing member having a central aperture and having a diameter sized to close the outlet aperture of the hub;
an upper washer having a diameter substantially equal to the diameter of the sealing member and having a central aperture;
a spring having an upper end and a lower end;
an upper spring cup located between the upper washer and the upper end of the spring, the upper spring cup having a recess into which the upper end of the spring is seated and having a central aperture;
a lower spring cup having a recess into which the lower end of the spring is seated and having a central aperture; and
a lower washer on a side of the lower spring cup opposite the recess, and having a central aperture;
wherein the pressure relief element is supported by an upper support member and a pin;
wherein the upper support member comprises a core and a plurality of legs extending radially away from the core, the core having a central aperture, the upper support member being located in the hub central bore so that the legs engage an inner lip of the hub;
wherein the pin further comprises a shank, a head on a first end of the shank, and the pin end being a second end of the shank; and
wherein the shank passes sequentially through the upper support member central aperture, the sealing member central aperture, the upper washer central aperture, the upper spring cup central aperture, the spring, the lower spring cup central aperture, and the lower washer central aperture.

14. A filter unit comprising an outer filter assembly, a bypass valve assembly, and an inner filter assembly:
wherein the outer filter assembly comprises:
a perforated tube defining a central bore;
an annular filter medium surrounding the perforated tube;
a first end cap securing one end of the perforated tube and the annular filter medium, and defining a first opening; and
a second end cap securing an opposite end of the perforated tube and the annular filter medium, and defining a second opening;
wherein the bypass valve assembly comprises:
a hub comprising a sidewall surrounding a central bore, an upper portion, a lower portion, and an outlet aperture in the lower portion;
a pressure relief element adjacent the hub and acting to prevent flow through the outlet aperture until a pressure differential value is exceeded; and
a pin comprising an external thread, the pin being located on an end of the pressure relief element opposite the hub;
wherein the inner filter assembly comprises:
a first closed end cap comprising a central core having an outer end and an inner end, an annular surface extending radially from the central core, and an outer sidewall extending axially from an outer perimeter of the annular surface towards the inner end, the central core containing a cavity running from the outer end to a cavity surface, and an internal threaded recess running from the cavity surface towards the inner end;
a second end cap; and
an inner element having a first end and a second end;
wherein the first closed end cap is attached to the first end of the inner element, the first end cap outer sidewall extending over an outermost surface of the inner element; and
wherein the second end cap is attached to the second end of the inner element;
wherein the external thread of the bypass valve assembly is joined with the internal threaded recess of the inner filter assembly;
wherein the lower portion of the bypass valve assembly hub is in sealing engagement with the first opening of the outer filter assembly; and
wherein the inner filter assembly is located within the perforated tube of the outer filter assembly.

15. The filter unit of claim 14, wherein a diameter of the upper portion of the bypass valve assembly hub is greater than a diameter of the first opening of the outer filter assembly; and
wherein the diameter of the upper portion of the bypass valve assembly hub is less than a diameter of the second opening of the outer filter assembly

16. The filter unit of claim 14, wherein a length from the upper portion of the hub to the second end cap of the inner filter assembly is less than a length of the outer filter assembly.

17. The filter unit of claim 14, wherein the second end cap of the inner filter assembly is an open end cap comprising an annular surface, an inner perimeter, and a central sidewall extending axially from the inner perimeter, the central sidewall surrounding a central bore;
wherein the second end cap of the outer filter assembly further comprises a primary annular surface and a primary central sidewall extending axially from an inner perimeter of the primary annular surface into the central bore of the perforated tube of the outer filter assembly;
wherein the primary central sidewall of the second end cap of the outer filter assembly is in sealing engagement with the central bore of the second end cap of the inner filter assembly; and
wherein the annular surface of the second end cap of the inner filter assembly rests on the primary annular surface of the second end cap of the outer filter assembly.

18. A recyclable filter element comprising a filter assembly and a bypass valve assembly;
wherein the filter assembly comprises:
a perforated tube;
an annular filter medium surrounding the perforated tube;
a first end cap securing one end of the perforated tube and the annular filter medium, and defining a first opening; and
a second end cap securing an opposite end of the perforated tube and the annular filter medium, and defining a second opening;
wherein the first opening has a diameter less than a diameter of the second opening; and
wherein the bypass valve assembly comprises:
a hub comprising a central bore, an upper portion, a lower portion, and an outlet aperture in the lower portion, wherein an outer diameter of the lower portion is less than an outer diameter of the upper portion;
a pressure relief element that acts to prevent flow through the outlet aperture until a pressure differential value is exceeded; and
a first rotary complementary joining mechanism,
wherein the pressure relief element is between the hub and the first rotary complementary joining mechanism;
wherein the lower portion of the bypass valve assembly hub fits into and makes a sealing engagement with the first opening of the filter assembly;
wherein the upper portion of the bypass valve assembly hub sits on the first end cap;
wherein the lower portion of the bypass valve assembly hub is unable to make a sealing engagement with the second opening of the filter assembly; and
wherein the bypass valve assembly can be separated from the filter assembly.

19. The recyclable filter element of claim 18, wherein the diameter of the opening diameter of the filter assembly is greater than the outer diameter of the upper portion of the hub.

20. The recyclable filter element of claim 18, further comprising an annular recess in an exterior surface of the lower portion of the hub, and an o-ring placed in the annular recess.

21. The recyclable filter element of claim 18, wherein the first end cap of the filter assembly does not include an o-ring, and wherein the second end cap of the filter assembly includes an o-ring located in an annular recess.
